(19) United States
(12) Patent Application Publication
(10) Pub. No.: US 2020/0036306 A1
(43) Pub. Date: Jan. 30, 2020

(54) PUMP CONTROL DEVICE

(71) Applicant: AISIN SEIKI KABUSHIKI KAISHA, Kariya-shi, Aichi (JP)

(72) Inventors: Koki AOYAGI, Kariya-shi, Aichi (JP); Kazuhiko HOSHIKO, Nagoya-shi, Aichi (JP)

(73) Assignee: AISIN SEIKI KABUSHIKI KAISHA, Kariya-shi, Aichi (JP)

(21) Appl. No.: 16/497,488

(22) PCT Filed: Feb. 28, 2018
(86) PCT No.: PCT/JP2018/007443

§ 371 Date: Sep. 25, 2019

(30) Foreign Application Priority Data
Apr. 3, 2017 (JP) 2017-073931

(51) Int. Cl. H02P 6/16; H02M 7/5387

(52) U.S. Cl. CPC H02P 6/16; H02M 7/53871

(57) ABSTRACT

A pump control device includes a temperature information acquisition section for acquiring temperature information indicative of a temperature of oil circulated by an electric pump at time of start-up of this electric pump, an advance amount setting section for setting an advance amount of a coil relative to a permanent magnet among coils of a motor that drives the electric pump based on the temperature information, the coil being energized to apply an attraction force relative to the permanent magnet of the motor, an inverter including three sets of arm portions each having a high-side switching element and a low-side switching element connected in series between a first power line and a second power line connected to a voltage lower than a voltage of the first power line, the inverter controlling a current in the coil, and an energization control section for starting energization to the inverter based on the advance amount.

### TECHNICAL FIELD

This invention relates to a pump control device for controlling an operation of an electric powered pump (electric pump).

### BACKGROUND ART

Conventionally, an electric pump has been used for controlling circulation of oil. With this type of electric pump, the pump is operated by a rotational force outputted from a motor. Here, the oil undergoes change in its viscosity according to its temperature (“oil temperature” hereinafter). As the oil temperature increases, the viscosity becomes lower, thus reducing the load applied to the electric pump. Conversely, as the oil temperature decreases, the viscosity becomes higher, thus increasing the load applied to the electric pump. For this reason, even when the motor is being driven at a constant speed, the rotational speed of the electric pump can change according to the oil temperature, thus, stepping-out may result. As techniques to prevent such stepping-out, techniques are known from e.g. Patent Documents 1 and 2 identified below.

A motor drive control device disclosed in Patent Document 1 includes an advance reference voltage generation section for generating an advance reference voltage, a counter-electromotive voltage comparison section configured to generate a phase signal of each phase according to a cross timing between the advance reference voltage and a counter-electromotive voltage of each phase of the motor, and a control section configured to detect a rotational speed of a motor based on the phase signal of each phase and to increase the advance reference voltage according as the rotational speed drops from a high speed to a low speed and to reduce the advance reference voltage according as the rotational speed rises from a low speed to a high speed.

A brushless motor control device for an electric pump disclosed in Patent Document 2 includes a driving circuit configured to supply three-phase driving power to a motor coil of a brushless motor for driving the electric pump, a start-up means for starting the brushless motor by forcibly rotating a rotor by switching a plurality of energization patterns to a motor coil according to a predetermined order, and an oil temperature detection means for detecting an oil temperature of working oil supplied by the electric motor, the start-up means being configured to quicken the cycle of switching of the energization patterns in accordance with increase of the oil temperature.

### BACKGROUND ART DOCUMENTS

### Patent Documents

Patent Document 1: Japanese Unexamined Patent Application Publication No. 2016-174478

Patent Document 2: Japanese Unexamined Patent Application Publication No. 2012-130178

In the technique disclosed in Patent Document 1, the advance control is effected based on a counter-electromotive power generated in the coil of the motor. However, when such counter-electromotive power is unstable (e.g. immediately after start-up), the advance control cannot be effected appropriately. Further, when no counter-electromotive power is generated at the initial stage of energization, the advance control is not possible.

Here, variation occurs in the load to the electric pump in accordance with variation in the oil temperature as described above. With occurrence of such load variation, change occurs also in the period (surge period) when a surge occurs at the time of switchover of the energization. On the other hand, the motor for driving the electric pump is controlled based on a position signal outputted according to rotation of the motor. With such control, it is not possible to detect the position signal appropriately during occurrence of the surge. For this reason, there is provided a masking period so that the position signal is not detected during occurrence of a surge. In case a predetermined masking period is applied to the technique disclosed in Patent Document 1 for instance, if the switching cycle of the energization pattern is varied according to the oil temperature, the surge period can become longer than the masking period when the oil temperature is low. Then, if a position signal is detected in this surge period, detection of this position signal cannot be effected accurately, leading to possibility of stepping-out. Conversely, when the oil temperature is high, the masking period can become too long relative to the surge period, so that the masking may be applied inadvertently to a point at which detection of zero-cross is desired. As a result, delay in energization switching may result in deterioration of efficiency, which can result even in stepping-out eventually. Moreover, in the technique disclosed in Patent Document 1, the control is effected based on a counter-electromotive force generated in the coil of the motor. With this, appropriate control may become impossible e.g. at the time of start-up of the motor when the counter-electromotive force becomes unstable. As described above, with the technique disclosed in Patent Document 1, appropriate driving of the electric pump becomes impossible.

In view of the above, there is a need for a pump control device that can drive an electric pump appropriately, irrespectively of load variation.

### Solution to the Problem

According to a characterizing feature of a pump control device relating to the present invention, the pump control device comprises:

a temperature information acquisition section for acquiring temperature information indicative of a temperature of oil circulated by an electric pump at time of start-up of this electric pump;

an advance amount setting section for setting an advance amount of a coil relative to a permanent magnet among coils of a motor that drives the electric pump based on the temperature information, the coil being energized to apply an attraction force relative to the permanent magnet of the motor;

an inverter including three sets of arm portions each having a high-side switching element and a low-side switching element connected in series between a first power line and a second power line connected to a voltage lower than a voltage of the first power line, the inverter controlling a current in the coil; and

an energization control section for starting energization to the inverter based on the advance amount.

With the above-described characterized configuration, a load on the electric pump is estimated from an oil temperature and then advance control can be carried out according to the magnitude of the estimated load. Further, it is also possible to change the advance amount at the time of start-up or after the start-up, whereby the advance control corresponding to a particular operational state becomes possible.

Preferably, the pump control device further comprises a storage section storing relationship between the oil temperature and the advance amount, the advance amount setting section being configured to set the advance amount based on the oil temperature indicated by the temperature information and the relationship stored in the storage section.

With the above-described arrangement, the advance amount setting section can easily set an advance amount. Therefore, since an advance amount can be set in accordance with a load of the electric pump, the electric pump can be operated appropriately.

Further, preferably, the pump control device further comprises:

a masking period setting section for setting a masking period such that in a non-energization period in which both the high-side switching element and the low-side switching element included in one arm portion of the three sets of arm portions are opened on the temperature information, a masking period comprised of a period shorter than the non-energization period is set immediately after start of this non-energization period based on the temperature information;

a detection section for detecting a rotational speed of the motor after completion of the masking period in the non-energization period; and

the energization control section driving the inverter based on result of the detection of the detection section.

With the above-described arrangement, the masking period can be set long in association with drop in the oil temperature, whereas the masking period can be set short in association with rise in the oil temperature. Thus, as an appropriate masking period can be set according to the load on the electric pump, no delay will occur in zero-cross detection, whereby erroneous surge detection can be prevented. Therefore, as the sensing performance can be improved, sensor-less driving of the motor is made possible without stepping-out. Moreover, the range of useable oil temperature can be extended also advantageously.

### BRIEF DESCRIPTION OF DRAWINGS

FIG. 1 is a block diagram schematically showing a configuration of a pump control device,

FIG. 2 is a view schematically showing a configuration of a motor,

FIG. 3 is an explanatory view of an advance amount,

FIG. 4 is an explanatory view of energization periods and non-energization periods,

FIG. 5 is a view showing relationship between an oil temperature and a surge period, and

FIG. 6 is a flowchart illustrating processing effected by the pump control device.

### EMBODIMENTS

A pump control device relating to the present invention is configured to be capable of driving an electric pump appropriately, irrespectively of variation occurring in a load. Next, such pump control device 1 in this embodiment will be explained.

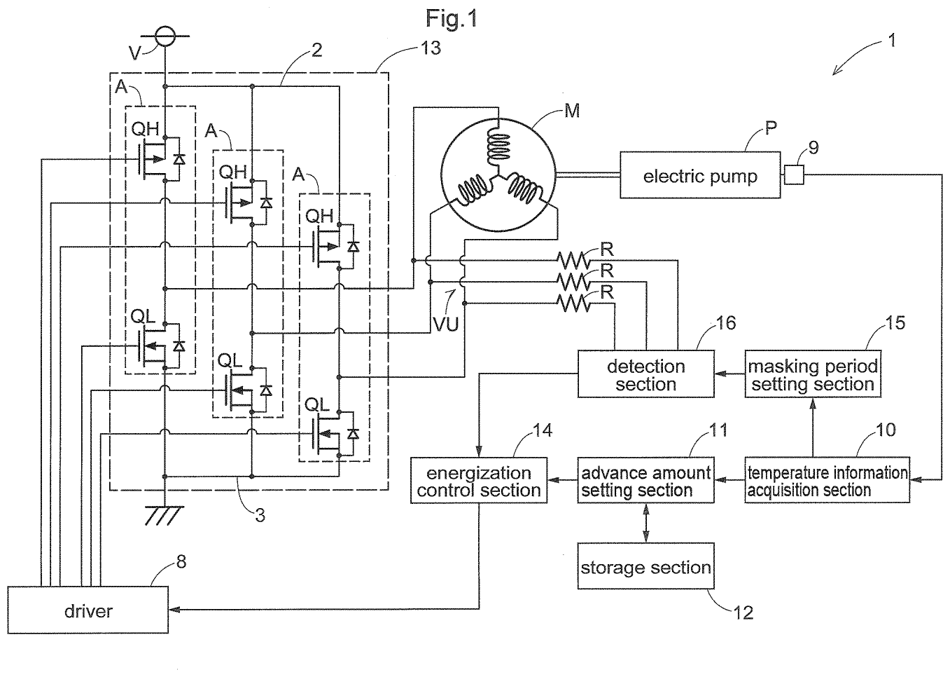

FIG. 1 is a block diagram schematically showing a configuration of the pump control device 1. As shown in FIG. 1, the pump control device 1 according to the instant embodiment includes functional sections comprised respectively of a temperature information acquisition section 10, an advance amount setting section 11, a storage section 12, an inverter 13, an energization control section 14, a masking period setting section 15 and a detection section 16. In particular, the respective functional sections of the temperature information acquisition section 10, the advance amount setting section 11, the storage section 12, the energization control section 14, the masking period setting section 15 and the detection sections 16 are constituted of hardware including a CPU as a core component thereof and/or software in order to effect driving of the electric pump P.

The temperature information acquisition section 10 acquires temperature information indicative of a temperature of oil circulated by an electric pump P at the time of start-up of this electric pump P. The electric pump P is driven by a rotational force outputted from a motor M. In the above, the “oil circulated by the electric pump P” refers to oil which is circulated in association with driving of the electric pump P. The temperature information acquisition section 10 acquires temperature information indicative of a temperature of such oil circulated in association with driving of the electric pump P, prior to this driving of the electric pump P. Incidentally, advantageously, the temperature of the oil may be detected by a temperature sensor 9 and the result of detection by the temperature sensor 9 may be transmitted to the temperature information acquisition section 10. Then, the temperature information acquisition section 10 transmits this detection result of the temperature sensor 9 as the “temperature information” to the advance amount setting section 11 to be described below.

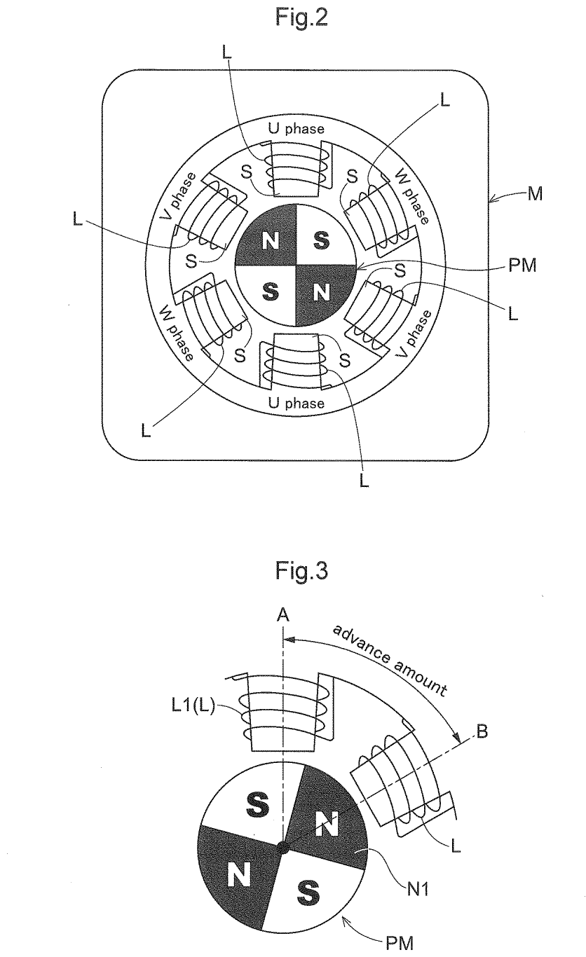

The advance amount setting section 11, sets, based on the temperature information, an advance amount of a coil L relative to a permanent magnet PM of the motor M among a plurality of coils L (see FIG. 2) of this motor M driving the electric pump P, which particular coil L is energized to apply an attraction force relative to the permanent magnet PM. The temperature information is transmitted from the temperature information acquisition section 10 as described above. In the above, the “motor M driving the electric pump P” means a motor M which outputs a rotational force as a power source of the electric pump P. Here, FIG. 2 shows a schematic diagram of a three-phase motor having four poles and six slots as an example of the motor M. In the example shown in FIG. 2, the motor M includes six coils L and two sets of permanent magnet PM. As well-known, a three-phase motor is rotated by an attraction force and a repulsion force acting between a magnetic field generated around a coil L which power is supplied to this predetermined coil L among the six coils L and the magnetic flux of the permanent magnet PM. In the example shown in FIG. 2, the respective coils L are fixed to stators S whereas the permanent magnets PM are rotated.

Here, as is well-known in the art, even when a voltage is applied to a coil L, a current will not flow in this coil L immediately, but there occurs a predetermined phase lag. This phase lag becomes greater as the rotational speed of the motor M becomes higher. For this reason, in order allow an attraction force and a repulsion force to act appropriately between the coil L and the permanent magnet PM, it is necessary to advance the phase of the voltage to be applied to the coil L, in consideration of such phase lag of the current flowing in the coil L. Such control is referred to as “advance (angle) control” and its angle (amount) is called an “advance (angle) amount”.

Specifically, in this pump control device 1, in order to allow an attraction force and a repulsion force to be applied appropriately between the permanent magnet PM and the coil L, as illustrated in FIG. 3, before a permanent magnet PM (the N pole N1 in the example of FIG. 3) to which an attraction or repulsion force is applied reaches a position (a position A in FIG. 3) in opposition to the coil L (coil L1 in the example of FIG. 3) (e.g. when located at the position B in FIG. 3), the coil L1 is energized. The angle from the position (position A) where the permanent magnet PM (N pole N1) opposes to the coil L1 to a position (position B) of prior energization corresponds to the above-described “advance (angle) amount”, which is set by the advance amount setting section 11.

The storage section 12 stores relationship between the oil temperature and the advance amount. Preferably, this relationship can be set as such a relationship that the advance amount is set to a predetermined angle (e.g. 15 degrees) if e.g. the oil temperature is higher than or equal to a predetermined temperature (e.g. 80 degrees in Celsius) whereas the advance amount is set to an angle smaller than the predetermined angle (e.g. 15 degrees) if the oil temperature is lower than the predetermined temperature (e.g. 80 degrees in Celsius). In this embodiment, the advance amount setting section 11 sets an advance amount based on the relationship between the oil temperature indicated by the temperature information and the relationship stored in the storage section 12.

The inverter 13 includes three sets of arm portions A each having a high-side switching element QH and a low-side switching element QL connected in series between a first power line 2 and a second power line 3 connected to a voltage lower than a voltage of the first power line 2 and controls a current flowing in the coil L. Here, “a first power line 2” means a cable connected to a power source V. Further, “a second power line 3 connected to a voltage lower than a voltage of the first power line 2” means a cable which is applied with a voltage lower than an output voltage of the power source V and this corresponds in particular to a grounded cable in this embodiment.

In the instant embodiment, the high-side switching element QH is constituted of using a P-MOSFET, whereas the low-side switching element QL is constituted of using an N-MOSFET. The high-side switching element QH has its source terminal connected to the first power line 2 and its drain terminal connected to a drain terminal of the low-side switching element QL. The source terminal of the low-side switching element QL is connected to the second power line 3. The high-side switching element QH and the low-side switching element QL connected as described above together constitute the arm portion A. And, the inverter 13 includes three sets of such arm portions A.

The gate terminals of the high-side switching element QH and the low-side switching element QL respectively are connected to a driver 8. This driver 8 is provided between an energization control section 14 to be described later and the inverter 13 and receives input of PWM signals generated by the energization control section 14. The driver 8 improves driving ability of the PWM signals and outputs the resultant signals to the inverter 13. The drain terminals of the high-side switching element QH of the respective arm portions A are connected to three terminals included in the motor M respectively.

The energization control section 14 controls energization to the inverter 13 based on the advance amount. The advance amount is set by the advance amount setting section 11 based on the oil temperature and transmitted therefrom. The energization control section 14 generates PWM signals and outputs the generated PWM signals to the driver 8 in accordance with the advance amount. With this, PWM control of the inverter 13 becomes possible. The PWM control by PWM signals is well-known in the art, so its explanation is omitted here. With this, the pump control device 1 sets an advance amount of the coil L corresponding to the permanent magnet PM of the motor M, in accordance with the oil temperature at the time of start-up of the electric pump P. And, as the energization control section 14 effects PWM control of the inverter 13 in accordance with the set advance amount, the electric pump P can be started appropriately.

A non-energization period is a period when both the high-side switching element QH and the low-side switching element LH included in one arm portion A of the three sets of arm portions A are opened. Within this non-energization period, the masking period setting section 15 sets, based on the temperature information, a masking period comprising a period shorter than the non-energization period, immediately after start of the non-energization period. The temperature information is transmitted from the temperature information acquisition section 10. The three sets of arm portions A mean the three sets of arm portions A together constituting the inverter 13.

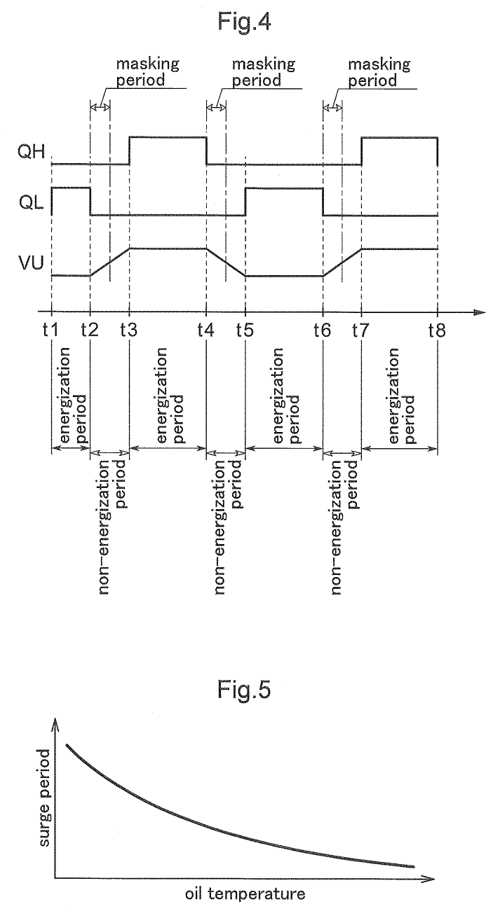

Here, FIG. 4 shows an explanatory view of the energization periods and the non-energization periods. In FIG. 4, there are shown energization states of the high-side switching element QH and the low-side switching element QL of one arm portion A of the three sets of arm portions A included in the inverter 13. As described above, the high-side switching element QH and the low-side switching element QL are controlled by PWM signals. In this embodiment, as the high-side switching element QH is constituted of a P-MOSFET, its PWM signal takes an inverted form of the waveform shown at the uppermost row in FIG. 4. Also, in FIG. 4, there is also shown a voltage waveform of the portion denoted with a mark VU in FIG. 1.

The energization period is a period when one of the high-side switching element QH and the low-side switching element LH included in one arm portion A of the three sets of arm portions A is closed. Here, “one of the high-side switching element QH and the low-side switching element QL included in one arm portion A of the three sets of arm portions A is closed” means that one of the high-side switching element QH and the low-side switching element QL included in one arm portion A of the three sets of arm portions A is energized. Specifically, in the case of the example shown in FIG. 4, such energization period corresponds to the period form timing t1 to timing t2, the period from timing t3 to timing t4, the period from timing t5 to timing t6 and the period from timing t7 to timing t8. In these periods, one of the high-side switching element QH and the low-side switching element QL included in one arm portion A of the three sets of arm portions A is under the energized state, so these periods are called “energization periods”.

The non-energization period is a period when both the high-side switching element QH and the low-side switching element QL included in one arm portion A of the three sets of arm portions A are opened. Here, “both the high-side switching element QH and the low-side switching element QL included in one arm portion A of the three sets of arm portions A are opened” means both the high-side switching element QH and the low-side switching element QL included in one arm portion A of the three sets of arm portions A are non-energized. Specifically, in the case of the example shown in FIG. 4, such non-energization period corresponds to the period from timing t2 to timing t3, the period from timing t4 to timing t5 and the period from timing t6 to timing t7. In these periods, both the high-side switching element QH and the low-side switching element QL included in one arm portion A of the three sets of arm portions A are under the non-energized state, so these periods are called “non-energization periods”.

In such non-energization period, a surge is generated immediately after transition from the energization period. Thus, immediately after start of the non-energization period, there is set a masking period comprised of a period shorter than the non-energization period. Here, “there is set a masking period comprised of a period shorter than the non-energization period” means that such masking period is not set for the entire non-energization period, but set only for a part of the non-energization period. In particular, the masking period is started immediately after position detection (zero-cross detection) and is released prior to next position detection. FIG. 4 shows one example of such masking period. Such masking period is set by the masking period setting section 15 and the duration of the masking period is set according to the temperature information, namely, oil temperature. Here, one example of relationship between the surge period (period when surge occurs) and temperature of oil (oil temperature) is shown in FIG. 5. On the other hand, the masking period needs to be longer than the surge period. Then, the masking period setting section 15 sets the duration of the masking period, based on the oil temperature indicated by the temperature information and the relationship between the oil temperature and the surge period such as the one shown in FIG. 5.

The detection section 16 detects a rotational speed of the motor M after completion of the masking period, within the non-energization period. In the instant embodiment, the detection section 16 detects a position of a rotor (not shown) of the motor M, based on a motor current flowing in the motor M. In the instant embodiment, the detection section 16 is connected via respective resistors R to the cables respectively connecting the drain terminals of the high-side switching elements QH of the respective arm portions A described above to the three terminals included in the motor M. With this connection arrangement, the detection section 16 detects the motor current and detects (calculates) the rotor position. As this detection is well-known, explanation thereof will be omitted herein. The detection section 16 detects the rotational speed of the motor M based on the rotor position. With this, it becomes possible to detect a rotational speed of the motor M, without being influenced by surge. The result of detection by the detection section 16 is transmitted to the energization control section 14 and the energization control section 14 drives the inverter 13, based on the detection result of the detection section 16.

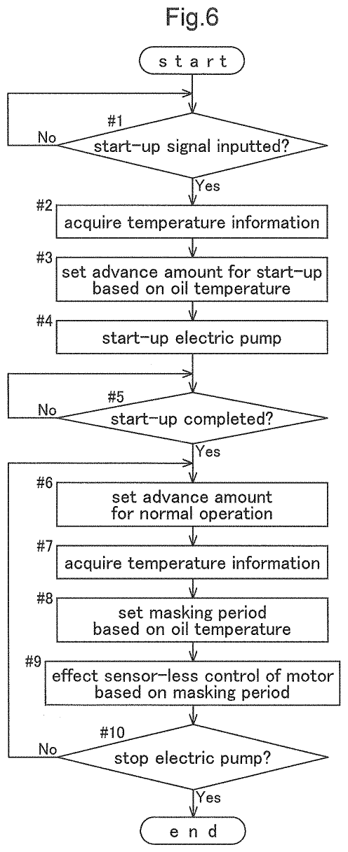

Next, the processing carried out by the pump control device 1 will be explained with reference to the flowchart of FIG. 6. First, upon input of a start-up signal for starting up the electric pump P (step #01: YES), the temperature information acquisition section 10 acquires temperature information indicative of an oil temperature (step #2). Based on the temperature of oil (oil temperature) indicated by this temperature information, the advance amount setting section 11 sets an advance amount at the time of start-up of the electric pump P (step #3), whereby the electric pump P is started (step #4).

Upon completion of the start-up of the electric pump P (step #5: YES), the advance amount setting section 11 sets an advance amount for a normal time (normal operation time) of the electric pump P (step #6). This advance amount for normal time is set based not on the temperature information indicating an oil temperature, but on a counter-electromotive force generated in the coil L.

The temperature information acquisition section 10 will acquire temperature information even when the electric motor P enters a state of normal operation (step #7). The masking period setting section 15 sets, within the non-energization period, a masking period based on the temperature of oil (oil temperature) indicated by the temperature information (step #8). Then, based on the set masking period, the detection section 16 detects a rotational speed of the motor M and based on this detection result, the energization control section 14 effects sensor-less control of the motor M (step #9). In case the electric motor P is not stopped (step #10: NO), the process returns to step #6 to continue the processing.

As described above, with the inventive pump control device 1, the advance amount of the electric pump P is controlled according to an oil temperature, thus realizing advance control at the time of start-up without instability at the time of initial energization or counter-electromotive force. Moreover, since a larger torque is required at the time of start-up as compared with the normal operation time, an optimal advance amount can be set in consideration thereto. Further, since an optimal advance amount can be set at the time of start-up, there will occur no trouble or delay (step, reverse rotation) at the time of start-up, so the start-up speed can be improved. As the torque is smaller at the time of normal operation time as compared with the time of start-up, by setting an optimal advance amount, the electric pump P can be driven with high efficiency.

### Other Embodiments

In the foregoing embodiment, it was explained that the pump control device 1 includes the storage section 12 storing the relationship between the oil temperature and the advance amount. However, the storage section 12 can be omitted. In this case, preferably, the advance amount setting section 11 may be configured to set an advance amount, based on e.g. a formula specifying the relationship between the oil temperature and the advance amount.

In the foregoing embodiment, it was explained that the masking period setting section 15 sets the masking period based on the temperature information. However, the masking period setting section 15 may be configured to set the masking period, not based on the temperature information.

In the foregoing embodiment, a four-pole, six-slot three-phase motor was cited as an example of the motor M. However, the number of poles and the number of slots are only exemplary. These numbers may be different. Further, the motor M need not be a three-phase motor.

In the foregoing embodiment, it was explained that the relationship between the oil temperature and the advance amount is such relationship that the advance amount is set to a predetermined angle in case the oil temperature is higher than or equal to a predetermined temperature whereas the advance amount is set to an angle smaller than the predetermined angle in case the oil temperature is lower than the predetermined temperature. However, the relationship may be set as such a relationship that the lower the oil temperature, the smaller the advance amount, and the higher the oil temperature, the greater the advance amount.

### INDUSTRIAL APPLICABILITY

The present invention is applicable to a pump control device for controlling an operation of an electric pump.

### DESCRIPTION OF SIGNS

1: pump control device

2: first power line

3: second power line

10: temperature information acquisition section

11: advance amount setting section

12: storage section

13: inverter

14: energization control section

15: masking period setting section

16: detection section

A: arm portion

L: coil

M: motor

P: electric pump

PM: permanent magnet

QH: high-side switching element

QL: low-side switching element

1. A pump control device comprising:
a temperature information acquisition section for acquiring temperature information indicative of a temperature of oil circulated by an electric pump at time of start-up of this electric pump;
an advance amount setting section for setting an advance amount of a coil relative to a permanent magnet among coils of a motor that drives the electric pump based on the temperature information, the coil being energized to apply an attraction force relative to the permanent magnet of the motor;
an inverter including three sets of arm portions each having a high-side switching element and a low-side switching element connected in series between a first power line and a second power line connected to a voltage lower than a voltage of the first power line, the inverter controlling a current in the coil; and
an energization control section for starting energization to the inverter based on the advance amount.

2. The pump control device of claim 1, further comprising a storage section storing relationship between the oil temperature and the advance amount, the advance amount setting section being configured to set the advance amount based on the oil temperature indicated by the temperature information and the relationship stored in the storage section.

3. The pump control device of claim 1, further comprising:
a masking period setting section for setting a masking period such that in a non-energization period in which both the high-side switching element and the low-side switching element included in one arm portion of the three sets of arm portions are opened, a masking period comprised of a period shorter than the non-energization period is set immediately after start of this non-energization period based on the temperature information;
a detection section for detecting a rotational speed of the motor after completion of the masking period in the non-energization period; and
the energization control section driving the inverter based on result of the detection of the detection section.
